(19) United States
(12) Patent Application Publication
(10) Pub. No.: US 2016/0188975 A1
(43) Pub. Date: Jun. 30, 2016

(54) BIOMETRIC IDENTIFICATION VIA RETINA SCANNING

(71) Applicant: RETINA BIOMETRIX, LLC, San Antonio, TX (US)

(72) Inventors: TIMOTHY P. CLELAND, San Antonio, TX (US); Yi An Chang, Austin, TX (US); Raeanna Chen, Austin, TX (US); Brian Milman, San Antonio, TX (US); Patrick Simmons, Austin, TX (US); Satyajit Balial, Austin, TX (US); Shela Gu, New Orleans, LA (US); Nazariy Shaydyuk, Austin, TX (US); Angel Zubieta, South San Francisco, CA (US)

(21) Appl. No.: 14/837,892

(22) Filed: Aug. 27, 2015

Related U.S. Application Data
(63) Continuation of application No. 13/942,336, filed on Jul. 15, 2013, now abandoned.
(60) Provisional application No. 61/671,149, filed on Jul. 13, 2012.

(51) Int. Cl. G06K 9/00

(52) U.S. Cl. CPC G06K 9/00617; G06K 9/00604; G06K 9/0061

(57) ABSTRACT

Various systems, processes, and techniques may be used to achieve biometric identification via retina scanning. In some implementations, systems, processes, and techniques may include the ability to scan a retina using a scanning laser ophthalmoscope to acquire at least one retina image, analyze the image to identify retina blood vessels, and identify a plurality of branch points of the retina blood vessels. The systems processes, and techniques may also include the ability to calculate a data set that represents the identified branch points, compare the calculated data set representing the branch points against at least one pre-stored data set representing retina branch points, and determine whether the calculated data set corresponds to the pre-stored data set.

### RELATED APPLICATIONS

This application claims priority to and the benefit of U.S. Patent Application No. 61/671,149, which is entitled “Non-Mydriatic Retinal Scanner For Biometric Identification” and was filed on Jul. 13, 2012. This prior application is herein incorporated by reference in its entirety.

### BACKGROUND

Biometrics is the use of distinctive biological and/or behavioral characteristics to identify an individual. Archeological evidence shows that the history of biometrics dates as early as 6,000 B.C., when human fingerprints were used to associate a person with an event or a transaction. Ancient Egyptians used the concept of biometric identity verification for many functions of administrative and commercial purposes. They kept records of discrete anatomical measurements as well as more general descriptions of individual features. The Sumerians considered handprints as identifiers.

The first modern wide-spread use of biometrics was the capture of hand images for use in identification, developed in 1858 by Sir William Herschel in India to prevent workers from improperly claiming another employee's paycheck. Biometric technology then progressed quickly. The Henry system was developed in 1896 in India, and quickly became the standard identification system. The system was picked up by Great Britain, then the New York civil service, then the United States Army and the United States Navy. The widespread use of fingerprint identification led to the development of automated fingerprint scanning and identifying systems. Presently, fingerprint identification is still the most common form of biometric identification used in the world, but many high security institutions such as the FBI, CIA, and NASA have recently employed iris scanning. Other biometric technologies that exist utilize speech, the face, a signature, and the palm.

The processing of complex patterns in the human iris was computationally constrained until 1994. With advances in computer hardware and automated pattern recognition technology, John Dougman developed an algorithm that is still used in almost all commercial iris scanning devices. There are multiple commercially available devices today. In fact, SRI International's Iris on the Move biometric identification systems can quickly and accurately capture iris images of subjects in motion at distances up to 10 feet, resulting in throughput as high as 30 people per minute.

The idea to use retina vasculature patterns for personnel authentication originated from the work of Dr. Carleton Simon and Dr. Isodore Goldstein, published in the New York State Journal of Medicine in 1935. Every eye, including those of identical twins, has its own unique pattern of blood vessels, allowing for accurate identification. Image acquisition for retina scanning, however, was very impractical and expensive back then, and retina scanning technology did not come to the market until 1981 when suitable infrared light sources and detectors became available. Today, fundoscopes are regularly used by medical professionals to image the retina.

### SUMMARY

Various systems, processes, and techniques may be used to achieve biometric identification via retina scanning. In some implementations, a process for biometric identification via retina scanning may include scanning a retina using a scanning laser ophthalmoscope to acquire at least one retina image, analyzing the image to identify retina blood vessels, and identifying a plurality of branch points of the retina blood vessels. The process may also include calculating a data set that represents the identified branch points, comparing the calculated data set representing the branch points against at least one pre-stored data set representing retina branch points, and determining whether the calculated data set corresponds to the pre-stored data set. The process is implemented by a system including a computer, which may include hardware and/or software components for executing one or more of the operations.

In certain implementations, scanning a retina using a scanning laser ophthalmoscope may include generating a red retina image, a green retina image, and a blue image retina image, and analyzing the at least one image to identify retina blood vessels may include converting the three color images into a first grayscale image. In particular implementations, analyzing the image to identify retina blood vessels may further include removing foreground noise from the first grayscale image to create a second image, removing the blood vessels from the second image to create a third image, and subtracting the third image from the first image.

In some implementations, identifying a plurality of branch points of the retina blood vessels may include thinning images of the identified blood vessels to a single pixel in width.

Calculating a data set that represents the identified branch points may include determining a predetermined number of branch points that are the nearest neighbors to each identified branch point, determining the distances from the nearest neighbors to each branch point, and computing distance ratios between the nearest neighboring branch points for each branch point and the angles therebetween.

Determining whether the calculated data set corresponds to the pre-stored data set may include determining whether a predetermined number of branch points correspond between the pre-stored data set and the calculated data set.

In certain implementations, comparing the calculated data set representing the branch points against at least one pre-stored data set representing retina branch points may include comparing the calculated data set against a plurality of data sets representing retina branch points.

Some implementations may include granting access if the calculated data set corresponds to the pre-stored data set. Particular implementations may include determining whether blood is flowing through the retina blood vessels and denying access if there is no blood flowing through the retina blood vessels.

Various implementations may include one or more features. For example, when using a scanning laser ophthalmoscope, a retina image may be acquired in a non-mydriatic manner. Traditional retina cameras, like fundoscopes, typically require a highly-dilated pupil diameter (e.g., at least 3.7 mm), which may be uncomfortable to users. Using a scanning laser ophthalmoscope, a retina image may be acquired with a pupil diameter of about 2.0 mm. Moreover, fundoscopes typically require a technician to assist in imaging the retina, which makes them less user friendly. As another example, compared to other types biometric identification systems, retina identification may be significantly more difficult to fool. The oldest form of biometrics, fingerprints, has proven effective, but the collection of high quality prints is difficult, and age and occupation can alter a person's fingerprints. Moreover, images of fingerprints can also be fabricated and used to spoof security systems, and once a fingerprint is faked, it cannot be replaced on the user. Additionally, iris scanners can be fooled by fake-iris contact lenses. The retina, however, is buried inside the body, making it inaccessible to tampering.

Various other features will be apparent to those skilled in the art from the following detailed description and the accompanying figures and claims.

### BRIEF DESCRIPTION OF THE DRAWINGS

FIG. 1 is a block diagram illustrating selected components of an example system for biometric identification via retina scanning.

FIG. 2 is an image of a retina taken with a scanning laser ophthalmoscope.

FIG. 3 is a flowchart illustrating selected operations of an example process for biometric identification via retina scanning.

FIG. 4 is a flowchart illustrating selected operations of an example process for extracting retina blood vessel data.

FIG. 5 is a flowchart illustrating selected operations of another example process for extracting retina blood vessel data.

FIG. 6 illustrates blood vessel patterns determined for the retina image in FIG. 2 using the processes in FIGS. 4-5.

FIG. 7 is a flowchart illustrating select operations of an example process for determining whether data for a number of retina branch points is associated with a pre-stored data set for a number of branch points.

FIG. 8 is a line drawing illustrating operational characteristics of the process in FIG. 7.

FIG. 9 is plot illustrating operational characteristics of the process in FIG. 7.

FIG. 10 is a flowchart illustrating select operations of another example process for determining whether a set of data for a number of retina branch points is associated with a pre-stored data set for a number of branch points.

FIG. 11 is a line drawing illustrating operational characteristics of the process in FIG. 10.

FIG. 12 is a flowchart illustrating select operations of an example process for determining whether a scanned retina is alive.

FIG. 13 is a block diagram illustrating selected components of an example computer system for biometric identification via retina scanning.

### DETAILED DESCRIPTION

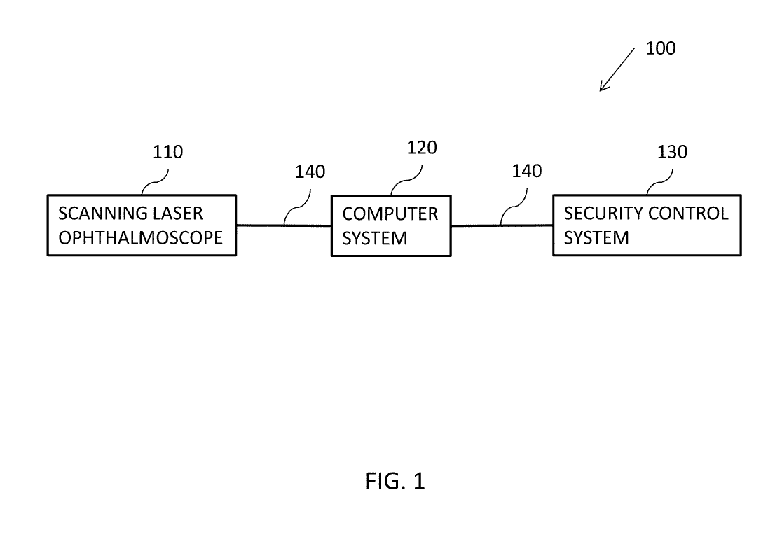

FIG. 1 illustrates an example system 100 for biometric identification via retina scanning. System 100 includes a scanning laser ophthalmoscope 110, a computer system 120, and a security control system 130.

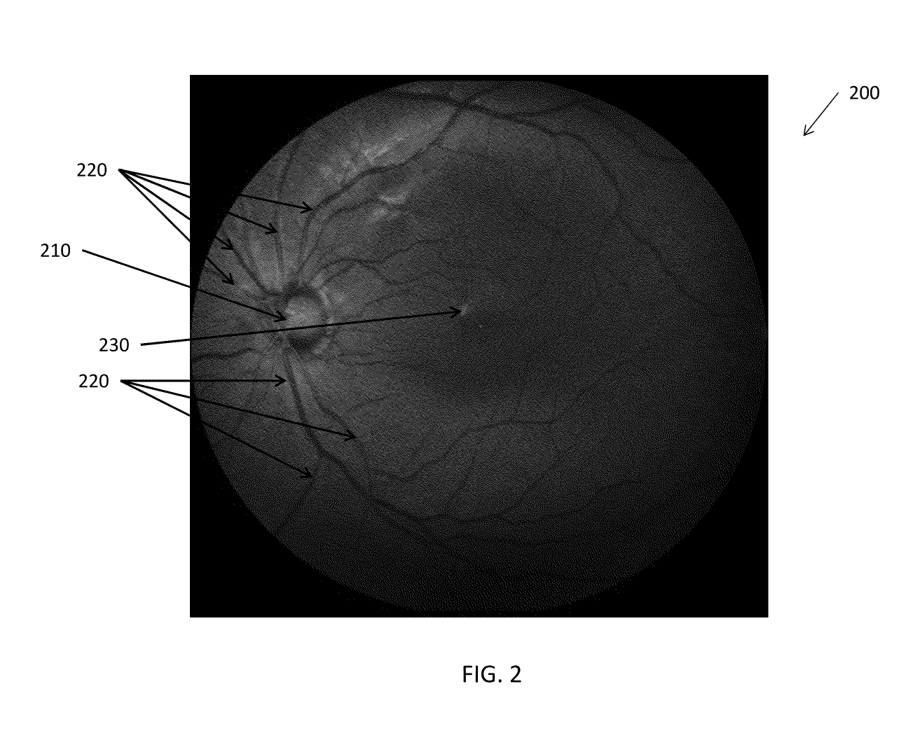

Scanning laser ophthalmoscope 110 is able to generate an image of a retina. In particular implementations, scanning laser ophthalmoscope 110 may generate three images of the retina—one in the red spectrum, one in the green spectrum, and one in the blue spectrum. An example scanning laser ophthalmoscope is the EasyScan SLO available from i-Optics in The Hague, Netherlands. The EasyScan SLO uses horizontal and vertical mirrors to shine narrow beams of green light (e.g., λ=532 nm) and infrared (IR) light (e.g., λ=785 nm) on the retina. FIG. 2 illustrates an example retina image 200 generated by an EasyScan SLO.

As seen in FIG. 2, the retina typically contains an optic disc 210 and a plurality of blood vessels 220. Optic disc 210 is the spot on the left from which blood 220 vessels emerge. Image 200 also shows that the macula, which is located in the center spot, contains a fovea 230.

Computer system 120 is responsible for processing the image acquired by scanning laser ophthalmoscope 110 and determining whether the image is associated with a retina that has already been imaged (e.g., when setting up a security profile). Computer system 120 may, for example, include one or more processors (e.g., microprocessors) and memory for storing instructions and data. Computer system 120 may be a single computer (e.g., laptop, desktop, workstation, etc.) or a collection of computers (e.g., coupled together by a network).

Security control system 130 is responsible for activating a security device if computer system 120 determines that the currently scanned retina is associated with a retina that has already been imaged. Security control system 130 may, for example, grant access to a physical facility or to a computer resource (e.g., a computer system, a database, and/or an application). For example, security control system 130 may include an electromagnetic lock that would unlock if the retina identification algorithm detects a match. As another example, security control system may include an Authentication, Authorization, and Accounting (AAA) computer module.

Scanning laser ophthalmoscope 110, computer system 120, and security control system 130 are coupled together by links 140. Links 140 may be busses, wires, cables, fiber-optic cables, or legs of a communication network (e.g., portions of a LAN, WAN, or the Internet). Links 140 may be physical (e.g., busses, wires, or fiber-optic cables) or non-physical (e.g., wireless channels). Thus, scanning laser ophthalmoscope 110, computer system 120, and security control system 130 may be located near or far from each other.

In certain modes of operation, scanning laser ophthalmoscope 110 may scan an eye to acquire at least one image of a retina. In some implementations, images of the eye may be generated in the red spectrum, the green spectrum, and the blue spectrum. The image(s) may then be conveyed to computer system 120, which may process the retina image(s) to identify retina blood vessels. Identifying the retina blood vessels may, for example, be accomplished by applying a morphological closing operator to a retina image, which will remove the blood vessels, and subtracting the resulting image from the original retina image. The blood vessels may also be identified by applying a Frangi filter to a retina image (e.g., red).

Computer system 120 may also identify branch points of the retina blood vessels. Identifying branch points may, for example, be accomplished by analyzing a blood vessel to see if it contains a bifurcation. Computer system 120 may also calculate a data set that represents the identified retina branch points. The data set may, for example, be based on the spatial orientation of the branch points relative to a point (e.g., in polar coordinates) or the geometries between branch points (e.g., distances to nearest neighbors).

Computer system 120 may additionally compare the calculated data set against at least one pre-stored data set representing retina branch points. Comparing the calculated data set against at least one pre-stored data set may, for example, be accomplished by determining whether the data for a branch point in one set corresponds to the data for a branch point in another set. Computer system 120 may also determine whether the calculated data set corresponds to the pre-stored data set. Determining whether the calculated data set corresponds to the pre-stored data set may, for example, be accomplished by determining whether a number of branch points (e.g., 5-20) between the data sets correspond.

If the calculated data set corresponds to the pre-stored data set, indicating that the currently scanned retina corresponds to the previously scanned retina, computer system 120 may generate a message for security control system 130. The message may, for example, be a control signal or an instruction. Based on the message from computer system 120, security control system 130 may grant a user access. Granting access may, for example, include deactivating a lock for a physical facility or allowing access to a computer resource (e.g., hardware, software, and/or data).

System 100 has a variety of features. For example, by using a scanning laser ophthalmoscope, the retina image may be acquired in a non-mydriatic manner. Traditional retina cameras, like a fundoscopes, typically require a pupil diameter of at least 3.7 mm, which may have to be obtained using eye drops and/or other techniques. In system 100, a pupil diameter of about 2.0 mm may be used. Although this may not obtain as wide of a field of view and, hence, have less information, this is more comfortable to users. Moreover, fundoscopes typically require a technician to assist in imaging the retina, but users of system 100 may not require any assistance.

Compared to other types biometric identification systems, system 100 is significantly more difficult to fool. The oldest form of biometrics, fingerprints, has proven effective, but the public perception of fingerprint identification is weak, collection of high quality prints is difficult, and age and occupation can alter a person's fingerprints. Moreover, images of fingerprints can also be fabricated and used to spoof security systems, and once a fingerprint is faked, it cannot be replaced on the user. Face recognition was thought to be a good means of identification, but facial recognition is sensitive to changes in light and expression, people's faces change over time, and the current technology in facial recognition produces a lot of false positives. Voice recognition could have been effective because the sensors (microphones) are easily available, but sensor and channel variances are difficult to control. Finally, iris scanning was thought to be the best solution because the iris is protected by the cornea and believed to be stable over an individual's lifetime, but the image turns out to be very difficult to capture, there are concerns about capturing an image of the eye using a light source, the scan cannot be verified by a human, and there is a lack of existing data. Moreover, iris scanners can be fooled by fake-iris contact lenses. Compared to these other techniques, the retinometric approach promises to be the least vulnerable to tampering—the retina is embedded deep within a body organ, making it less prone to tampering.

Biometric identification via retina imaging may have a variety of applications. For example, it could be used in financial transactions. Additionally, the healthcare system is ranked second only to the financial system when it comes to biometric identification. Today, more and more hospitals and companies are implementing biometric identification techniques for security purposes and patient records. As the healthcare system switches from a paper-based system to an electronic one, biometric identification will slowly become one of the best ways of tracking records.

Although FIG. 1 illustrates one implementation of a system for biometric identification via retina imaging, other systems may include fewer, additional, and/or a different arrangement of components. For example, computer system 120 could be incorporated into scanning laser ophthalmoscope 110. As another example, security control system 130 may be part of computer system 120. For instance, the security control system may grant access to processing capabilities, applications, and/or data on computer system 120. As an additional example, a retina imaging device other than a scanning laser ophthalmoscope could be used (e.g., a fundoscope).

In particular implementations, blood flow recognition may also be used to differentiate between living tissue and non-living duplicates. This additional security measure would overcome the duping disadvantages associated with other biometric identification systems because it would allow for a determination of whether live tissue was present versus some type of fake (e.g., an image or a reproduction).

As one example of blood flow recognition, laser speckle contrast imaging could be used. In laser speckle contrast imaging, the accumulation of scattered laser light off a surface produces a random interference, or speckle, pattern. Blurring of the speckle pattern is caused by moving particles (i.e. red blood cells) and can, if desired, be quantified to measure the flow. Since laser speckle contrast imaging is dependent on particles in motion, it can double as both a vasculature detection technique and a mechanism for blood flow recognition.

The light for the laser speckle imaging may be generated from a standard scanning laser ophthalmoscope or from an additional laser incorporated therewith. Light in the infrared (e.g., around 800 nm) could, for example, be used. The light could be generated from any number of standard lasers. The scattered light could, for example, be detected with a standard detector (e.g., CMOS or CCD). If incorporated into a scanning laser ophthalmoscope, a bimodal imaging modality could be achieved.

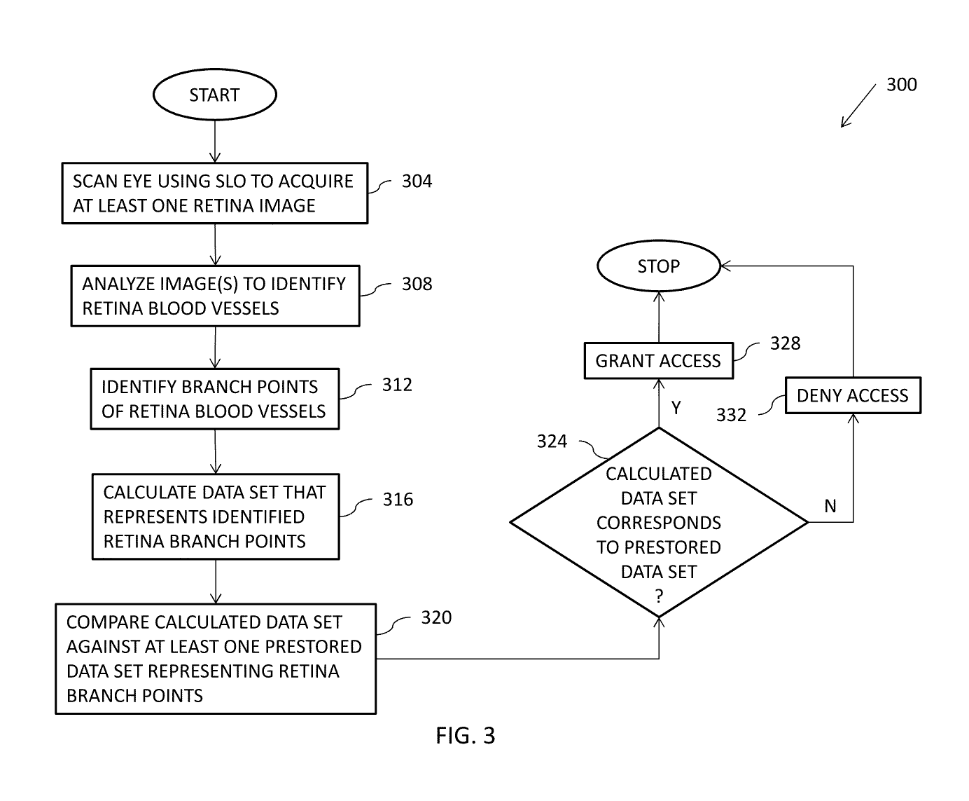

FIG. 3 illustrates selected operations of an example process 300 for biometric identification via retina scanning. Process 300 may, for example, be implemented by a system similar to system 100.

Process 300 calls for scanning an eye using a scanning laser ophthalmoscope to acquire at least one image of a retina (operation 304). In some implementations, images of the eye may be produced in the red spectrum, the green spectrum, and the blue spectrum.

Process 300 also calls for processing the retina image(s) to identify retina blood vessels (operation 308). Identifying the retina blood vessels may, for example, be accomplished by applying a Frangi filter to a retina image or applying a morphological closing operator to a retina image, which will remove the blood vessels, and subtracting the resulting image from the original retina image.

Process 300 further calls for identifying a plurality of branch points of the retina blood vessels (operation 312). Identifying a plurality of branch points may, for example, be accomplished by analyzing a blood vessel to see it contains a bifurcation. For example, blood vessels in an image could be thinned to a standard width (e.g., one pixel) and then analyzed as to whether there are sufficient pixels around a point for a bifurcation to have occurred. For instance, in cases in which the blood vessels were thinned to one pixel in width, if a pixel had three neighboring pixels, a bifurcation would be indicated.

Process 300 also calls for calculating a data set that represents the identified retina branch points (operation 316). The data set may, for example, be based on the spatial orientation of the branch points relative to a point (e.g., in polar coordinates) or the geometries between branch points (e.g., distances to nearest neighbors).

Process 300 further calls for comparing the calculated data set against at least one pre-stored data set representing retina branch points (operation 320). Comparing the determined data set against at least one pre-stored data set may, for example, be accomplished by determining whether the data for a branch point in one set corresponds to the data for a branch point in another set.

Process 300 also calls for determining whether the calculated data set corresponds to the pre-stored data set (operation 324). Determining whether the determined data set corresponds to the pre-stored data set may, for example, be accomplished by determining whether a number of branch points (e.g., 5-20) between the data sets correspond.

If the determined data set corresponds to the pre-stored data set, process 300 calls for granting access (operation 328). Granting access may, for example, include deactivating a lock for a physical facility or refusing access to a computer resource (e.g., hardware, software, and/or data).

If the determined data set does not correspond to the pre-stored data set, process 300 calls for denying access (operation 328). Denying access may, for example, include maintaining a lock for a physical facility or refusing access to a computer resource (e.g., hardware, software, and/or data).

Although FIG. 3 illustrates an example process for biometric identification via retina imaging, other processes for biometric identification via retina imaging may include fewer, additional, and/or a different arrangement of operations. For example, a process may not include scanning the eye with a scanning laser ophthalmoscope. The retina may, for example, be scanned with another type of device (e.g., a fundoscope). As another example, a process may include operations to form the pre-stored data set (e.g., by scanning an eye and performing branch point extraction when a user registers for a security system). As an additional example, a message may be provided to a user (e.g., through audio or visual techniques) indicating the results of a comparison.

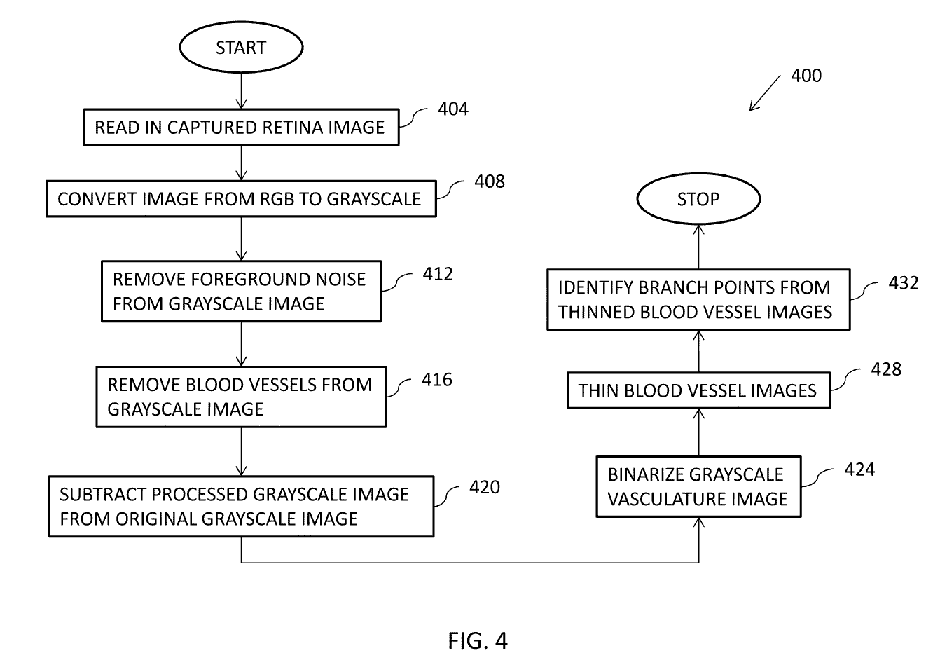

FIG. 4 illustrates selected operations of an example process 400 for extracting retina blood vessel data. Process 400 may, for example, be implemented by a computer system similar to computer system 120 in system 100.

Process 400 begins with reading in captured image data from a scanning laser ophthalmoscope (operation 404). Many ophthalmoscopes, like the Easy-SCAN SLO from i-Optics, scan the retina using a green laser and an infra-red laser and output red, green, and blue (RGB) images. For example, a 1024 by 1024 pixel RGB retinal image in .JPEG format may be acquired from an SLO device.

Process 400 also calls for converting the retina images from RGB to grayscale (operation 408). For example, a colored retina image may be converted to grayscale by applying the following formula:

Grayscale=0.3×R+0.59×G+0.11×B

Process 400 also calls for removing foreground noise from the grayscale image (operation 412). Removing the foreground noise may, for example, be accomplished by applying a morphological opening operator, which may remove small foreground noise.

Process 400 further calls for removing the blood vessels from the grayscale image (operation 416). Removing blood vessels may, for example, be accomplished by applying a morphological closing operator. At this point, the image should contain only the background.

Process 400 then calls for subtracting the processed grayscale image from the original grayscale image (operation 420), which should generate an image that displays only the vasculature. This may, for example, be performed by a matrix subtraction, which may be executed with a top-hat transformation.

Process 400 further calls for converting the grayscale vasculature image to a binary image (operation 424). This may, for example, be accomplished using a threshold value calculated from the image's gray-level intensity histogram. For example, the binarizing threshold could be set to 0.1, with pixel values below 0.1 set to 0 (black) while values above 0.1 are set to 1 (white). Binarization makes future calculations simpler to compute and pixels easier to evaluate by allowing mathematical morphing functions to be used.

Process 400 further calls for thinning the blood vessel images (operation 428). The vessel images may, for example, be thinned to one pixel in width by evaluating each pixel and their neighbors. The purpose of this function thins the blood vessels to facilitate the detection of branch points since the weight of the widths of the blood vessels vary. For instance, on a 3×3 grid where the center is the pixel being evaluated, if three or more neighboring pixels are part of a branch, then the value of the evaluated pixel will be altered to the background color. As another example, MatLab from The Mathworks, Inc. of Natick, Mass., USA has a built-in morphological function that may be used to accomplish this. For instance, the integrated bwmorph, (‘-thin’ argument) MatLab function thins the blood vessels to lines. At this point, the processed image shows white lines that represent blood vessels on a black background, which allowed for subsequent detection of branch points.

In some implementations, noise may be further reduced by setting a threshold of pixels (e.g., 10-50) for branch length. A pixel connected to less than the threshold number will be regarded as unnecessary information and set to a value of 0 (black).

Process 400 also calls for determining the branch points (operation 432). This may, for example, be performed by evaluating the neighbors of each pixel. For instance, at each pixel with a value of 1, if there are three or more neighboring pixels with the same value, a branch point is located. MatLab also has a function, bwmorph (‘branch points’ argument), that will return the coordinate points of the branch points.

Although FIG. 4 illustrates a process for extracting retina blood vessel data, other processes for extracting retina blood vessel data may include fewer, additional, and/or a different arrangement of operations. For example, a process may include scanning an eye to generate a retina image. As another example, a process may not convert an RBG image to grayscale (e.g., the image may already be in grayscale). As a further example, a process may perform a series of black-and-white morphological operations to clean up a black and white image.

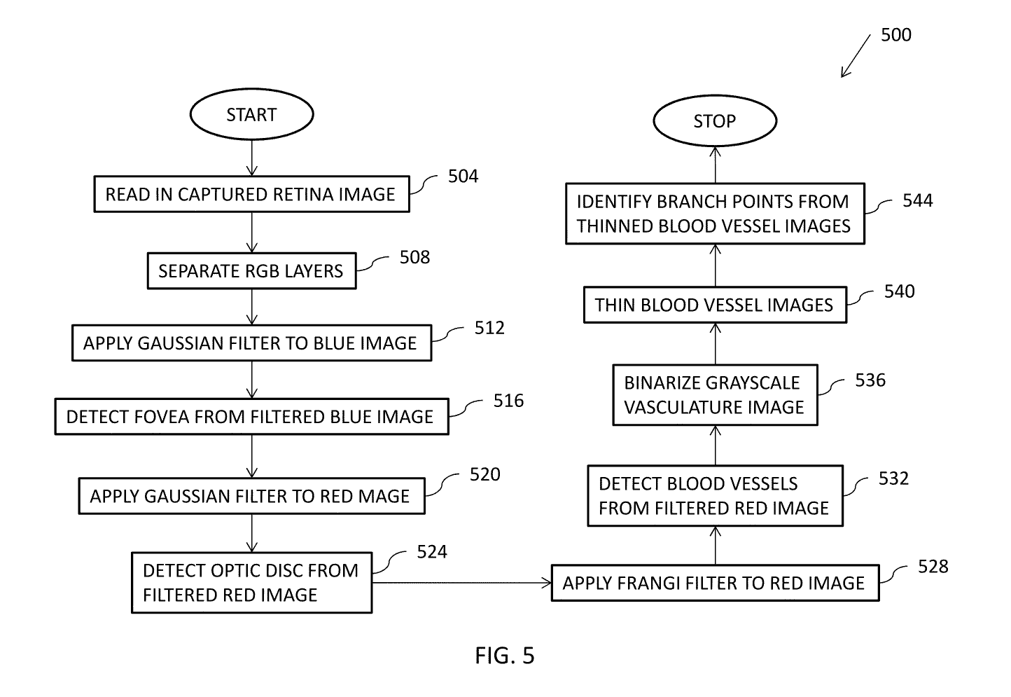

FIG. 5 illustrates another example process 500 for extracting retina blood vessel data. Process 500 may, for example, be implemented by a computer system similar to computer 120 in system 100.

Process 500 begins with reading in captured image data from a scanning laser ophthalmoscope (operation 504). Many ophthalmoscopes, like the Easy-scan SLO from i-Optics, scan the retina using a green laser and an infra-red laser and output red, green, and blue (RGB) images. For example, a 1024 by 1024 pixel RGB retinal image in .JPEG format may be acquired from the SLO device.

Process 500 also calls for separating the RGB layers (operation 508). Separating the RGB layers may, for example, be accomplished by determining where the images are stored in a matrix. For example, a three dimensional matrix may have two dimensions representing the pixels and a third dimension representing the colors.

Process 500 further calls for applying a Gaussian blur and median filter to the blue image (operation 512). A Gaussian blur (low pass filter) serves the purpose of suppressing high-frequency image components thereby reducing noise and smoothing edges. Blue light may be absent during image acquisition (e.g., only the infrared and green laser may be used by an SLO device). In a Gaussian blur, each pixel is set to a new value that is determined by the weighted average of its neighboring pixels. The level of blurring is determined by the value of the chosen standard deviation, σ, of the Gaussian function. In some implementations, the image may be analyzed with σ=6.

In some implementations, the blue image may be cropped to reduce processing time. The fovea typically occurs in the center of a retina scan. Thus, the peripheral regions of the image may be ignored in some cases.

Process 500 also calls for detecting the fovea from the filtered blue image (operation 516). The fovea is typically the darkest spot a retinal image because it absorbs the most light. After filtering the image, the image may be converted to black and white by setting a threshold of (e.g., 0.999). If the pixel values fall below or above the threshold, the values may be set in binary fashion (e.g., 0 (black) and 1 (white)). The resulting image should depict the fovea as a white dot. A function may then be applied to define and return the center of the fovea as a coordinate point. The argument of the function may, for example, call for an image with a single object whose geometric center needs to be determined. The centroid coordinates (Cₓ, C_{y}) may be calculated by the following equations, which compute the weighted average of the x and y-values:

$${C}_{x} = \frac{{Σ}_{n} {A}_{n} {C}_{{x}_{n}}}{{Σ}_{n} {A}_{n}} \qquad {C}_{y} = \frac{{Σ}_{n} {A}_{n} {C}_{{y}_{n}}}{{Σ}_{n} {A}_{n}}$$

To remove rotational and scaling displacement, the fovea may be positioned at the center of the image.

Process 500 further calls for applying a Gaussian blur and median filter to the red image (operation 520). A Gaussian blur filter may remove non-centered noise.

In some implementations, the red image may be cropped to reduce processing time and minimize interference from the rest of the image. The optic disc typically occurs in the center of a retina scan. Thus, the periphery of the image may be ignored in some cases. If the optic disc is not in the center of a retina scan, using the entire image may allow for a contrast in parts of image to be used. That is, for optic disc detection, one analyze the entire image and find the disc based on the features that are common to it.

Process 500 also calls for detecting the optic disc from the filtered red image (operation 524). In particular, non-optic area may be removed by testing each pixel value by a threshold (e.g., 0.9) and assigning a binary value. For example, if the value is less than the threshold value, the value may be changed to 0 (white color). The optic disc is typically a large dark mass in the red image.

A function may then be applied to define and return the center of the optic disc as a coordinate point. The argument of the function may, for example, call for an image with a single object whose geometric center needs to be determined. The centroid coordinates (Cₓ, C_{y}) may be calculated by equations that compute the weighted average of the x and y-values.

Process 500 also calls for applying a Frangi filter to the red image (operation 528). Because of the varying dimensions and orientations of the blood vessels in the retina, the Frangi filter is used since the filter allows for curvature detection. This function uses eigenvectors of the Hessian (a multiscale second-order local structure of an image) to numerically calculate the possibility that a region contains blood vessels. Such eigenvectors have the following geometric meaning:
The eigenvector with the largest absolute value is the second derivative, or Hessian, of a matrix that corresponds to the direction of the blood vessel with the greatest curvature.
Whereas, the eigenvector with the smallest absolute value is the direction of the blood vessel with the smallest curvature.
   Using a Frangi filter allows detection and extraction of the ridges and curvatures of blood vessels. The Frangi filter converts the blood vessels into a grayscale image.

In certain implementations, the process may extract the grayscale layer of the colored image before applying the Frangi filter. The main blood vessels are typically better revealed in the grayscale image than compared to other images. More image preprocessing may be implemented by using MatLab's image adjusting functions, imadjust(41⁻low in; high in], 1⁻low out; high out], gamma) and stretchlim(I), and median filter, medfilt2(a, [m n]). The imadjust function evaluates pixel values of a grayscale image in order to increase contrast in the image. If the values fall below ‘low in’ and above ‘high in’, they are mapped to ‘low out’ and ‘high out’, respectively. The imstretch function returns the ‘low in’ and ‘high in’ values to imadjust. It takes the top and bottom 1% of all pixel values by default. The functional purpose of a median filter is to reduce noise while preserving the edges of the blood vessels. The built-in feature evaluates an m-by-n neighborhood of a pixel and the edges of that neighborhood with Os. By using a color to grayscale image and applying a median filter, image noise may be reduced and a greater number of true branch points could be located. This prepares the image for the blood vessel segmentation.

Process 500 also calls for converting the resulting grayscale image to a binary image (operation 536). This may, for example, be accomplished using a threshold value calculated from the image's gray-level intensity histogram. For example, the binarizing threshold could be set to 0.1, with pixel values below 0.1 set to 0 (black) while values above 0.1 are set to 1 (white). Binarization makes future calculations simpler to compute and pixels easier to evaluate (e.g., by allowing mathematical morphing functions to be used).

Process 500 further calls for thinning the blood vessel images (operation 540). The vessels may, for example, be thinned to one pixel in width by evaluating each pixel and their neighbors. The purpose of this function thins the blood vessels to facilitate the detection of branch points since the weight of the widths of the blood vessels vary. For instance, on a 3×3 grid where the center is the pixel being evaluated, if three or more neighboring pixels are part of a branch, then the value of the evaluated pixel will be altered to the background color. As another example, MatLab has a built-in morphological function that may be used to accomplish this. For instance, the integrated bwmorph, (‘-thin’ argument) MatLab function thins the blood vessels to lines. At this point, the processed image shows white lines that represent blood vessels on a black background, which allows for subsequent detection of branch points.

In some implementations, noise may be further reduced by setting a threshold of pixels (e.g., 10-50). A pixel connected to less than the threshold will be regarded as unnecessary information and set to a value of 0 (black).

Process 500 also calls for identifying the branch points (operation 560). This may, for example, be performed by evaluating the neighbors of each pixel. For instance, at each pixel with a value of 1, if there are three or more neighboring pixels with the same value, a branch point is located. MatLab also has a function, bwmorph (‘branchpoints’ argument), that will return the coordinate points of the branch points.

Although FIG. 5 illustrates one process for extracting retina blood vessel data, other processes for extracting retina blood vessel data may include fewer, additional, and/or a different arrangement of operations. For example, a process may include generating the retina image. As another example, additional image enhancement techniques may be employed before applying the Frangi filter. For example, non-uniform illumination of the retinal image may be corrected, resulting in even lighting. As another example, image contrast may be enhanced (e.g., through adaptive histogram equalization). These techniques may improve vessel detection.

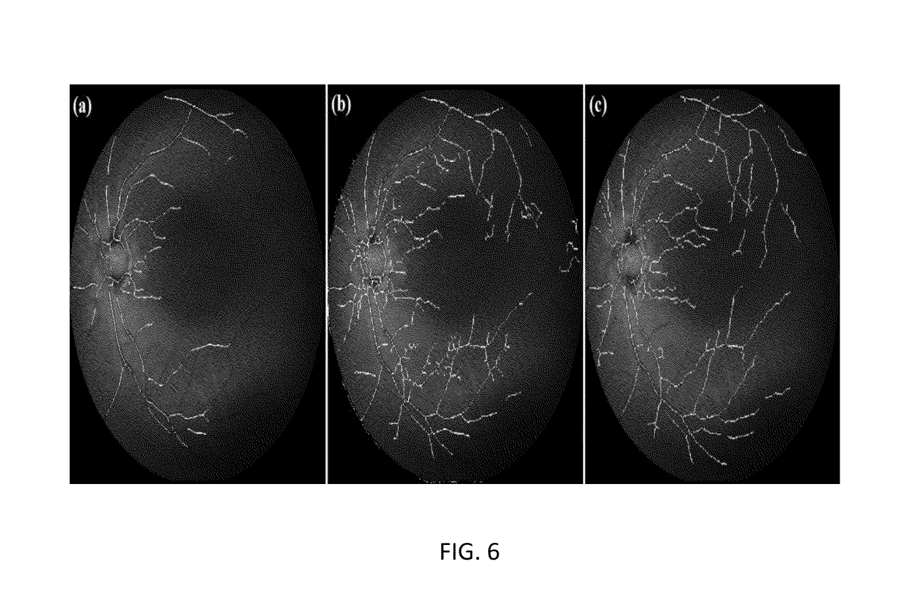

FIG. 6 illustrates a comparison between blood vessel extraction techniques. Image (a) shows the blood vessels extracted from retina image 200 by process 500. Image (b) shows the blood vessels extracted from retina image 200 by process 500 with additional image enhancement techniques. Image (c) shows the blood vessels extracted from retina image 200 by process 400.

As illustrated, process 400 detects significantly more vessels, provides fewer artifacts, and requires less computational time compared to the two previous algorithms. Thus, process 400 extracts more useful information from an image, potentially strengthening the subsequent matching portion of the image identification algorithm.

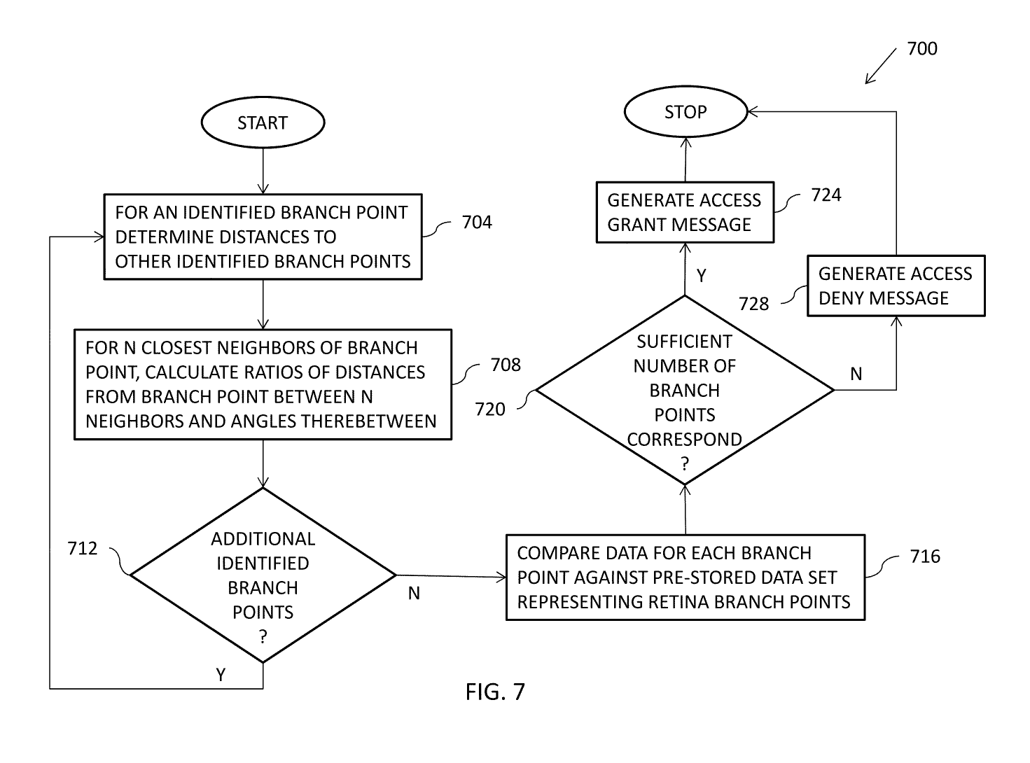

FIG. 7 illustrates select operations of an example process 700 for determining whether a set of data regarding a number of retina branch points is associated with another set of data regarding a number of branch points. Process 700 may be used with a number of algorithms that determine branch point location and may, for example, be performed by a computer system similar to computer system 120.

In general, process 700 calculates ratios of relational Euclidean distances of neighboring branch points to compare two branch points. In particular, the ratios of the distances from the neighboring branch points to the branch points of interest and the angles between the neighboring branch points are used.

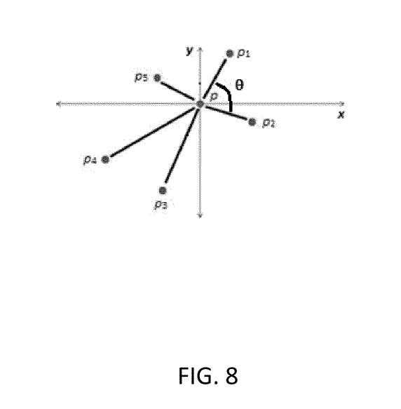

FIG. 8 illustrates a graphical representation of the underlying data. In the illustrated example, data for each branch point is compiled using its five nearest neighbors. In particular, the ratios of the distances between the nearest neighbors and the angles therebetween are determined and used for determining association with branch points from one or more other data sets.

Process 700 calls for determining distances from an identified branch point to the other identified branch points (operation 704). Determine distances between branch points may, for example, be accomplished with standard scaling and magnitude calculations. The distances from the branch point being analyzed may be computed or the distances between the branch points may have already been computed, in which case a simple search may be performed to determine which branch points are the closest.

Process 700 also calls for determining for a predetermined number of closest neighbors of the branch point being analyzed, ratios of distances from the branch point to the closest neighbors and the angles between the neighbors (operation 708). The distances may, for example, be computed with standard magnitude calculations, and the angles may be completed with standard vector calculations (e.g., dot product).

Using FIG. 8 as an example, for an original point p, the five surrounding points are called: p1, p2, p3, p4, p5. The distances between the points are calculated as: (p−p1), (p−p2), (p−p3), (p−p4), (p−p5). Then, ten ratios are taken:

(p−p1):(p−p2), (p−p1):(p−p3), (p−p1):(p−p4), (p−p1):(p−p5),

(p−p2):(p−p3), (p−p2):(p−p4), (p−p2):(p−p5), (p−p3):(p−p4),

(p−p3):(p−p5), (p−p4):(p−p5).

The ratios may be calculated as follows to ensure a ratio greater than or equal to 1:

$$( p - {p}_{a} ) \text{:} ( p - {p}_{b} ) = \frac{max [ ( p - {p}_{a} ) , ( p - {p}_{b} ) ]}{min [ ( p - {p}_{a} ) , ( p - {p}_{b} ) ]}$$

While obtaining the distance ratios between three points (pₐ, p, p_{b}), the algorithm also calculates and stores the angle formed by these points with point p at the vertex, as illustrated in one instance in FIG. 8. Each branch point is therefore assigned a set of ten ratios and their corresponding angles.

Process 700 also calls for determining whether there are additional identified branch points (operation 712). Depending on the fidelity of the blood vessel recognition algorithm, the number of branch points may be small (e.g., 10) or large (e.g., 100). If there is another identified branch point, process 700 calls for determining the distances from the next identified branch point to the other identified branch points (operation 704) and computing the distance ratios and angles between a number of the closest neighbors (operation 708) for the next branch point. Operations 704-712 may be performed until all of the identified branch points have been processed.

Once ratio/angle data has been determined for the identified branch points, process 700 calls for comparing the data ratio/angle for each branch point against a pre-stored data set for retina branch points (operation 716). The pre-stored data set may, for example, represent a particular retina—for example, when the person associated with the scanned retina has provided some other type of identification (e.g., name)—or may be a set of retinas (e.g., for a number of users authorized to access a site).

In some implementations, the comparison is broken up into two phases. The first phase of the comparison algorithm may be based on comparing the determined ratios and angles. Two branch points may, for example, be considered to be similar if their data sets contain at least two matching ratios and corresponding angles. Tolerance between potentially corresponding ratios and angles can be set to provide a stricter or more relaxed comparison metrics. In particular implementations, the tolerance for the distance ratios may be around 5% and the tolerance for the angles may be around 5 degrees.

This phase, however, does not guarantee that two similar points are necessarily the same. Therefore, a second phase may further evaluate pairs of similar points to distinguish the true matched pairs from points that only share some common features. That is, each selected pair contains a true point taken from the pre-stored data and a candidate point—a point from the input image that shares similar features with the true point. If the candidate point is found in the vicinity of the true point (set by a threshold radius r), the two points are considered to be the same. Tolerance between potentially corresponding points can be set to provide a stricter or more relaxed comparison metrics. In particular implementations, the tolerance for the points may set at about 15 pixels.

Process 700 also calls for determining whether a sufficient number of branch points correspond (operation 720). Although there may be some branch points that correspond between two data sets, if the number is not high enough, it may just be a statistical happenstance. A sufficient number of branch points may vary based on the level of security required. Correspondence between 10-20 branch points is probably acceptable for most applications, but other numbers may not be used in particular implementations.

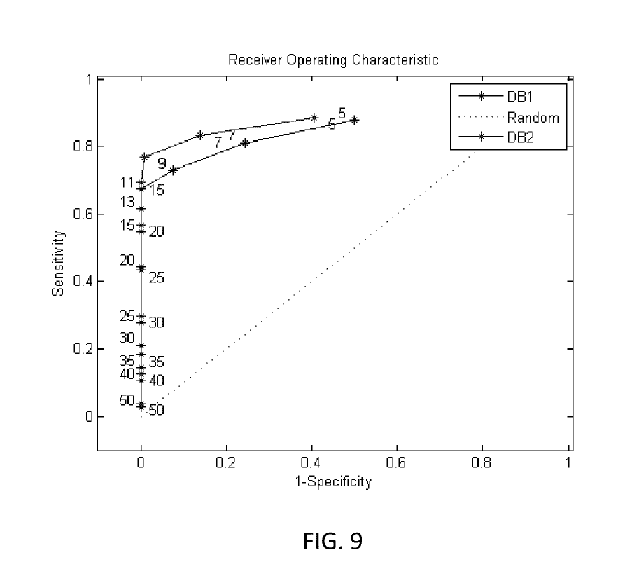

FIG. 9 illustrates a variance analysis that was performed based on the number of corresponding branch points for process 700. In this analysis, five retinal scans were acquired from 50 subjects. After obtaining fives images from each subject, the image pool contained 250 images. One image from each subject was used as the database image, while the other four images were deemed “test” images.

In order to test the algorithm for sensitivity and specificity, the pool of 50 database images was split into two 25-image databases. The 200 test images were compared against both databases, thereby creating the potential for both match and non-match results. As only 100 of these images had a match with the corresponding member in the database, the other 100 images should not be recognized by the matching algorithm.

The images were compared at a range of branch point thresholds. Each threshold represented the minimum number of matching branch points needed between the scanned image and the database image to constitute a match.

The robustness of the matching algorithm was evaluated based on the sensitivity and specificity criteria. Sensitivity was defined as the probability of a correct match, given that the user was stored in the database. Specificity was defined as the probability of a non-match, given that the user was not stored in the database. Positive outcomes (matches) occurred only when the amount of matched branch points from the input image across the database had a single maximum and had reached a specified threshold value. The positive outcomes were further categorized as true positive (TP) and false positive (FP). For the TP outcome, the input image must have matched a database entry with the same name, whereas FP outcome would result in the input image matching an entry with a different name. Similarly, negative outcomes (non-matches) occurred when the amount of matched branch points from the input image across the database did not reach specified threshold value or there were more than one equal maxima above the threshold. For true negative (TN) outcomes, the input image must have not belonged to a database whereas unrecognized image that belonged to the data base constituted a false negative (FN) outcome.

FIG. 9 illustrates the testing on both databases for different threshold values ranging from 5 to 50 branch points required for a match. Based on the resulting curves, an acceptable threshold for the matching algorithm was observed to be around 11 corresponding branch points. At this threshold, the average sensitivity from the two databases was 75%, whereas specificity was maintained both times at 100%. This setting ensures that no unauthorized user was granted access. Further testing may, however, reveal that another number of branch points may be useful.

If a sufficient number of branch points correspond between the two data sets, process 700 calls for generating a grant access message (operation 724). The message may, for example, be a signal to a device and/or an indication to the user. As mentioned previously, the access may be to a physical location (e.g., a room or building) or a non-physical location (e.g., a computer system). Process 700 is then at an end.

If a sufficient number of branch points do not correspond between the two data sets, however, process 700 calls for generating a deny access message (operation 728). Denying access may, for example, include informing the user that they are being denied access and/or generating an alert (e.g., an alarm signal and/or a message). Process 700 is then at an end.

Process 700 has a variety of features. For example, process 700 functions regardless of reasonable translational, rotational, and scaling differences between two images. Additionally, this process does not require the detection of reference points (e.g., fovea, optic disc, etc.). Furthermore, the number of matched branch points may be a discrete integer, whereas other processes (e.g., a correlation coefficient threshold) use a decimal number, which may require more memory space. Additionally, preliminary results indicate that the number of matched branch points between two “self” images is significantly higher than the number of matched points between “non-self” images.

Although FIG. 7 illustrates an example process for determining whether a set of data regarding a number of branch points is associated with another set of data regarding a number of branch points, other processes for determining whether a set of data regarding a number of branch points is associated with another set of data regarding a number of branch points may include fewer, additional, and/or a different arrangement of operations. For example, a process may not include granting or denying access. As another example, a process may include comparing the data for each branch point against a number of pre-stored data sets for retina branch points. Thus, instead of just authenticating a user's identity, the identity of the user may be determined from between a number of potential users.

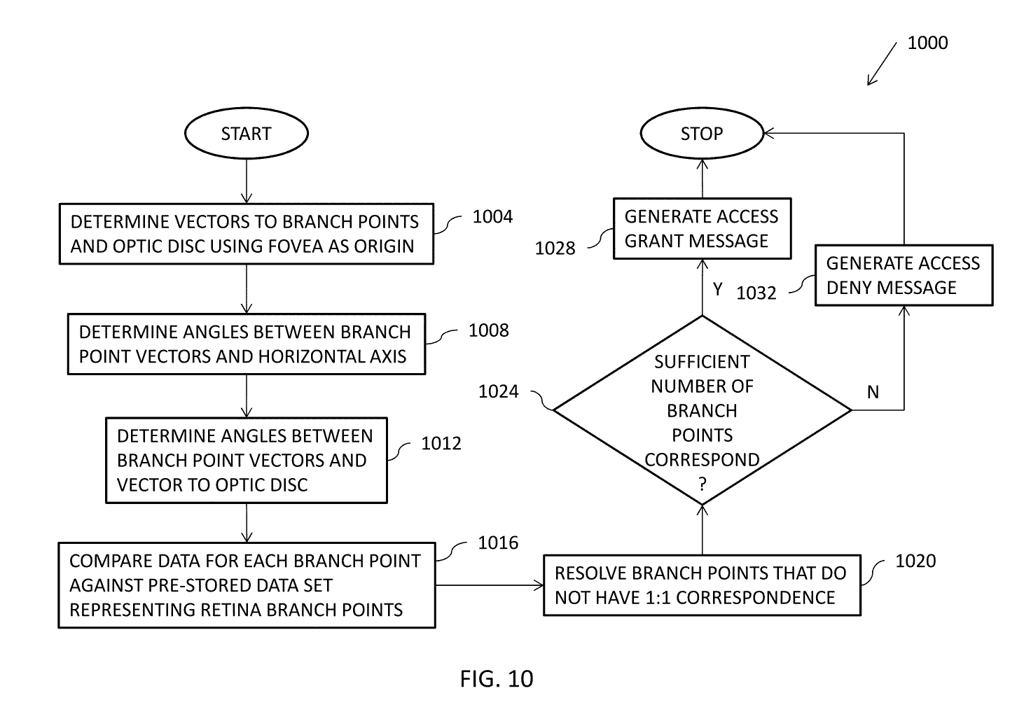

FIG. 10 illustrates select operations of another example process 1000 for determining whether a set of data for a number of branch points is associated with a pre-stored data set for a number of branch points. Process 1000 may be used with a number of algorithms that determine branch point location and may, for example, be performed by a computer system similar to computer system 120.

In general, process 1000 determines distances of branch points from the fovea and the angles between the horizontal of the image and the vector between the fovea and the optic disc. By setting the fovea and optic disc as the polar axis, it should be possible to standardize the orientation of each retinal image, regardless of its actual extent of rotation.

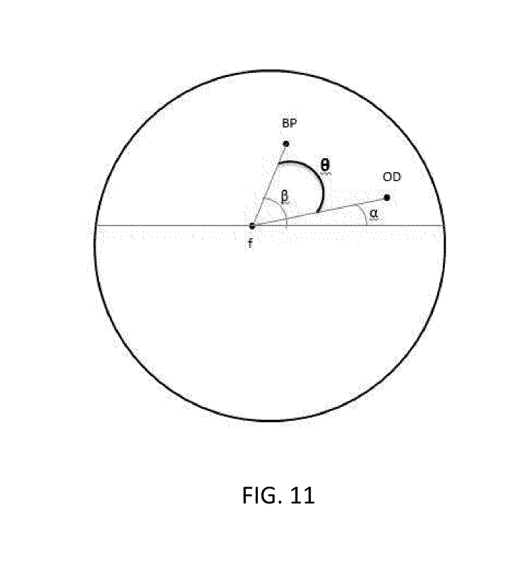

FIG. 11 illustrates a graphical representation of the underlying for this process. In particular, the fovea (F) is treated as the center of the system. Then, vectors are determined to each of the located branch points (BPs) and to the optic disc (OD). Polar coordinates for each of the branch points are then determined, with angles being defined between the branch point vectors and the horizontal of the picture and between the branch point vectors and the optic disc vector.

Process 1000 calls for determining vectors to the branch points and the optic disc using the fovea as the origin (operation 1004). The vectors may, for example, be determined using an origin translation to the fovea or vector subtraction.

Process 1000 also calls for determining angles between each branch point vector and the horizontal axis of the image (operation 1008). The angles may, for example, be computed using a vector dot product.

Process 1000 additionally calls for determining an angles between each branch point vector and the optic disc vector (operation 1012). The angles may, for example, be computed using a vector dot product.

At this point, each branch point may be described as a polar coordinate point (i.e., a distance, and two angles). This is performed by first defining the distance, d1, between the x-coordinates and y-coordinates of the fovea and optic disk. Since the centroid of the optic disc is slightly skewed above the horizontal set by the fovea position, the angle α is defined as the displaced angle between d1 and the horizontal. By inputting the Cartesian coordinates of the fovea and optic disc, the cart2pol function embedded MatLab function can easily perform those steps and return the polar coordinates, d1 and angle a. Then, a branch point coordinate is evaluated against the reference coordinate, and returns d2, the distance between the fovea the branchpoint, and angle β, the angle created by d2 and the horizontal. The final angle, θ, defines the angle created by d1 and d2. Using the polar coordinate system accounts for rotational and scaling issues.

In some implementations, a function may be implemented to remove branch points near the optic disc, the fovea and the edge of the image. To evaluate the branch point coordinates disqualified near the edge, a threshold radius (e.g., 475 pixels from the image center) may be used. To evaluate the branch point coordinates eliminated near the fovea and the optic disk, threshold radii (e.g., 100 pixels and 125 pixels, respectively) from the center of the fovea and optic disc may be used. Falling within these thresholds removes disqualifying branch points. These elimination thresholds may be useful because there are no branch points near the fovea and any branch points near the optic disk are probably part of the optic disc.

Process 1000 further calls for comparing the data for each branch point against a pre-stored data set for retina branch points (operation 1016). The data may be compared on the basis of the polar system coordinates previously determined. Tolerance between potentially corresponding points can be set to provide a stricter or more relaxed comparison metrics.

Process also calls for resolving branch points that do not have 1:1 correspondence with branch points in the data set, which can results with undesirable matches where single data points are matched to multiple input points and/or single input points are matched to multiple data points from the same image. The resolution may, for example, be accomplished using the Ford-Fulkerson method to find the maximum cardinality matching.

In particular, a bipartite maximum cardinality matching (MCM) algorithm may be used. This problem is bipartite when the matches are segregated by input side and data side, where data side is further separated by their origin image to perform the algorithm. The most efficient algorithm for the problem is Ford-Fulkerson's max flow algorithm. A function from Matlab BGL library of functions, maxflow, may, for example, be used. The maximum flow is the cardinality of the MCM of a bipartite graph when there are unit capacity edges between each input side point and the source, and all the points on the data side has unit capacity edge going to the sink.

Scoring may be determined by summing all the cardinality results from each image, summed by each known person. The person with highest score is identified, unless the score did not achieve above the predetermined threshold, in which case the authorization request is declined. Ford-Fulkerson may be used matching method. The branchpoints from an input image with defined branchpoint coordinates are matched to the defined branchpoints of five quality-based images. Two conditions must be met to identify the input branchpoints:
Each branchpoint in the database can only be matched to one input branchpoint.
Two branchpoints from the same image in the database cannot be matched to the same input branchpoint.

Process 1000 further calls for determining whether a sufficient number of branch points correspond (operation 1024). A sufficient number of branch points may be determined by experimental techniques (e.g., monte carlo). In particular implementations, the number of corresponding branch points may be between about 10-20.

If a sufficient number of branch points correspond between the two data sets, process 1000 calls for generating a grant access message (operation 1028). As mentioned previously, the access may be to a physical location (e.g., a room or building) or a non-physical location (e.g., a computer system). Process 1000 is then at an end.

If a sufficient number of branch points do not correspond between the two data sets, however, process 1000 calls for generating a deny access message (operation 1032). Denying access may, for example, include informing the user that they are being denied access and/or generating an alert (e.g., an alarm signal and/or a message). Process 1000 is then at an end.

Process 1000 has a variety of features. For example, the number of matched branch points may be a discrete integer, whereas other processes (e.g., a correlation coefficient threshold) use a decimal number, which may require more memory space. Additionally, preliminary results indicate that the number of matched branch points between two “self” images is significantly higher than the number of matched points between “non-self” images. Another feature of this implementation is that the exact centroid of the optic disc is not required because the angle of the vector created by the fovea and optic disc accounts for the rotational issues while the scaling issues do not have to be considered.

Although FIGS. 7 and 10 illustrate two processes for determining whether data for a number of branch points is associated with a pre-stored data set for a number of branch points, other processes for performing the determination are possible.

For example, image comparison could be accomplished by direct pixel-by-pixel comparison. For this technique to work well, there should be a high range of vessel detection (e.g., near 100%), which typically cannot be guaranteed due to the variability in image quality. Furthermore, this technique is sensitive to translational, rotational, and scaling differences and, thus, requires prior image registration. A global exhaustive alignment search may be able to accomplish this, but may be unacceptably time-consuming in certain implementations.

As another example, a correlation coefficient technique could be used. This technique could, for example, calculate the correlation coefficient r of two images (using the following equation:

$$r = \frac{{Σ}_{m} {Σ}_{n} ( {A}_{mn} - \overline{A} ) ( {B}_{mn} - \overline{B} )}{\sqrt{[ {Σ}_{m} {{Σ}_{n} ( {A}_{mn} - \overline{A} )}^{2} ] [ {Σ}_{m} {{Σ}_{n} ( {B}_{mn} - \overline{B} )}^{2} ]}}$$

where A and B are the two images, Aₘₘ and Bₘₘ are the values of individual pixels, and A bar and B bar are the average intensities of the two images, respectively. The correlation coefficient ranges between 0 and 1, where 0 means absolutely no relation and 1 means perfect match. Using the correlation coefficient method with binary images preserves vessel thickness yields workable results.

A database containing 20 retinal images—5 images of four different subjects—was created and processed according to the vasculature extraction algorithm in process 400. Then, each processed image was compared individually to all others in the database and the correlation coefficient was recorded for each comparison. Several experimental correlation coefficient values were used as the threshold to differentiate between a match and mismatch. Table 1 displays the sensitivity and specificity values for three different threshold values.

TABLE 1

| | Threshold Value | | |
|---|---|---|---|
| | 0.1 | 0.14 | 0.2 |
| Sensitivity | 1.0 | 1.0 | 0.89 |
| Specificity | 0.83 | 1.0 | 1.0 |

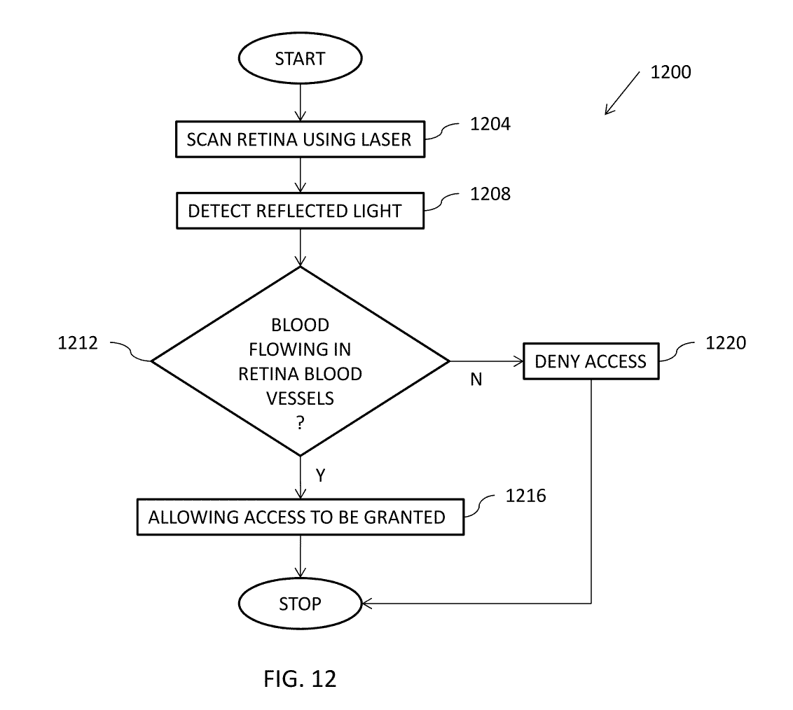

FIG. 12 illustrates select operations of an example process 1200 for determining whether a scanned retina is alive. Process 1200 may, for example, be accomplished by a system similar to system 100.

Process 1200 calls for scanning a retina using a laser (operation 1204). The laser may be part of a standard scanning laser ophthalmoscope or an additional laser incorporated therewith. The laser could also be incorporated into other retina scanning systems. Light in the infrared could, for example, be used. The light could be generated from any number of standard lasers.

Process 1200 also calls for detecting light reflected from the retina blood vessels (operation 1208). The light could, for example, be detected with a standard detector.

Process 1200 further calls for determining whether blood is flowing in the blood vessels of the retina being scanned (operation 1212). As one example of blood flow recognition, laser speckle contrast imaging could be used. In laser speckle contrast imaging, the accumulation of scattered laser light off a surface produces a random interference, or speckle, pattern. Blurring of the speckle pattern is caused by moving particles (i.e. red blood cells). In particular implementations, the blurring may be quantified to measure the flow. Since laser speckle contrast imaging is dependent on particles in motion, it may double as both a vasculature detection technique and a mechanism for blood flow recognition.

If there is blood flowing in the blood vessels of the retina being scanned, process 1200 calls for allowing access to be granted (1216). Determining that there is blood flowing in the retina blood vessels is typically not, by itself, sufficient to grant access. Thus, the retina blood vessel matching should still return a positive match. Process 1200 is then at an end.

If there is not blood flowing in the blood vessels of the retina being scanned, process 1200 calls for denying access. Determining that whether there is not blood flowing in the retina blood vessels is typically, by itself, sufficient to deny access. Thus, even if the retina blood vessel matching returns a positive match, access could be denied. Process 1200 is then at an end.

Process 1200 has a variety of features. For example, blood flow recognition may be used to differentiate between living tissue and non-living duplicates. This additional security measure would overcome the duping disadvantages associated with other biometric identification systems because it would allow for a determination of whether live tissue was present versus some type of duplicate (e.g., an image or a reproduction).

The flowchart and block diagrams in the figures illustrate the architecture, functionality, and operation of systems, methods, and computer program products of various implementations of the disclosure. In this regard, each block in the flowchart or block diagrams may represent a module, segment, or portion of code, which can include one or more executable instructions for implementing the specified logical function(s). It should also be noted that, in some alterative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or the flowchart illustration, and combination of blocks in the block diagrams and/or flowchart illustration, can be implemented by special purpose hardware-based systems the perform the specified function or acts, or combinations of special purpose hardware and computer instructions.

As will be appreciated by one skilled in the art, aspects of the present disclosure may be implemented as a system, method, or computer program product. Accordingly, aspects of the present disclosure may take the form of an entirely hardware environment, an entirely software embodiment (including firmware, resident software, micro-code, etc.), or an implementation combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this disclosure, a computer readable storage medium may be a tangible medium that can contain or store a program for use by or in connection with an instruction execution system, apparatus, or device.

A computer readable signal medium may include a propagated data signal with computer readable program code embodied therein, for example in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any medium, including but not limited to wireless, wireline, optical fiber cable, RF, etc. or any suitable combination of the foregoing.

Computer program code for carrying out operations for aspects of the disclosure may be written in any combination of one or more programming languages such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the disclosure are described below with reference to flowchart illustrations and/or block diagrams of methods, apparatus (systems), and computer program products according to implementations. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other device to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions that execute on the computer or other programmable apparatus provide processes for implementing the functions/acts specified in the flowchart and/or block diagram block or blocks.

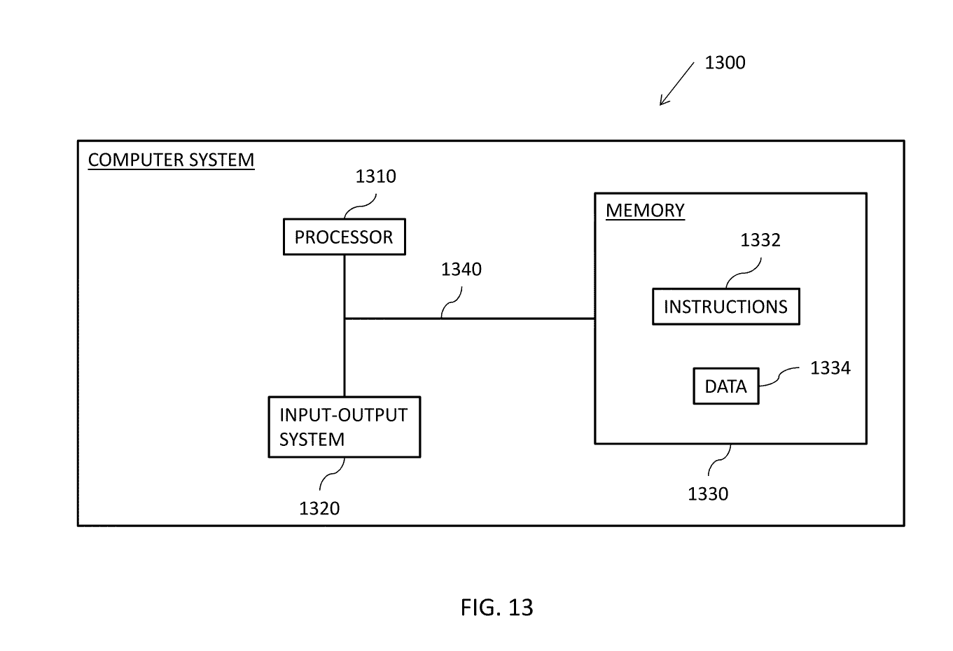

FIG. 13 illustrates selected components of an example computer system 1300 for performing biometric identification from a retina scan. System 1300 may, for example, be part of an ophthalmoscope, located locally with an ophthalmoscope, or located remotely located from an ophthalmoscope. System 1300 includes a processor 1310, an input-output system 1320, and memory 1330, which are coupled together by a network system 1340.

Processor 1310 may, for example, be a microprocessor, which could, for instance, operate according to reduced instruction set computer (RISC) or complex instruction set computer (CISC) principles. In general, processor 1310 may be any device that manipulates information in a logical manner.

Input-output system 1320 may, for example, include one or more communication interfaces and/or one or more user interfaces. A communication interface may, for instance, be a network interface card (whether wireless or wireless) or a modem. A user interface could, for instance, include one or more user input devices (e.g., a keyboard, a keypad, a touchpad, a stylus, a mouse, or a microphone) and/or one or more user output devices (e.g., a monitor, a display, or a speaker). In general, communication interface 1320 may include any combination of devices by which a computer system can receive and output information.

Memory 1330 may, for example, include random access memory (RAM), read-only memory (ROM), and/or disc memory. Various items may be stored in different portions of the memory at various times. Memory 1330, in general, may be any combination of devices for storing information.

Memory 1330 includes instructions 1332 and data 1334. Instructions 1332 may, for example, include an operating system (e.g., Windows, Linux, or Unix) and one or more applications, which may be responsible for analyzing retina images to identify various portions of the retina (e.g., optic disc, fovea, blood vessels, etc.) and performing an identification check based on these. Data 1334 may include the data required for the identification check (e.g., the biometric data to be authenticated against). In some implementations, a database of biometric factors may be located remotely from computer system 1300.

Network system 1340 is responsible for communicating information between processor 1310, input-output system 1320, and memory 1330. Network system 1340 may, for example, include a number of different types of busses (e.g., serial and parallel).

In certain modes of operation, computer system 1300 may receive a retina image through input-output system 1320. The image may be stored in data 1334. Processor 1310 may then analyze the image to identify the retina branch points. Processor 1310 may also calculate data regarding the retina branch points (e.g., position, spacing, neighbors, etc.). Using this data, processor 1310 may determine whether the calculated retina data corresponds to pre-stored retina data, which may be stored in a database in data 1334. If the calculated retina data corresponds to the pre-stored retina data, processor 1310 may generate an access grant message (e.g., a signal, an instruction, and/or a user notification), which may be used inside the computer system or sent to a remote device through input-output system 1320.

Processor 1310 may also determine whether blood is flowing in the blood vessels of the retina being scanned. If there is blood flowing in the blood vessels of the retina being scanned, processor 1310 may allowing access to be granted. If there is not blood flowing in the blood vessels of the retina being scanned, processor 1310 may deny access.

Processor 1310 may implement any of the other procedures discussed herein, to accomplish these operations.

The terminology used herein is for the purpose of describing particular implementations only and is not intended to be limiting. As used herein, the singular form “a”, “an”, and “the” are intended to include the plural forms as well, unless the context clearly indicates otherwise. It will be further understood that the terms “comprises” and/or “comprising,” when used in the this specification, specify the presence of stated features, integers, steps, operations, elements, and/or components, but do not preclude the presence or addition of one or more other features, integers, steps, operations, elements, components, and/or groups therefore.

The corresponding structure, materials, acts, and equivalents of all means or steps plus function elements in the claims below are intended to include any structure, material, or act for performing the function in combination with other claimed elements as specifically claimed. The description of the present implementations has been presented for purposes of illustration and description, but is not intended to be exhaustive or limited to the implementations in the form disclosed. Many modification and variations will be apparent to those of ordinary skill in the art without departing from the scope and spirit of the disclosure. The implementations were chosen and described in order to explain the principles of the disclosure and the practical application and to enable others or ordinary skill in the art to understand the disclosure for various implementations with various modifications as are suited to the particular use contemplated.

A number of implementations have been described for biometric identification via retina scanning, and several others have been mentioned or suggested. Moreover, those skilled in the art will readily recognize that a variety of additions, deletions, modifications, and substitutions may be made to these implementations while still achieving biometric identification via retina scanning. Thus, the scope of the protected subject matter should be judged based on the following claims, which may capture one or more concepts of one or more implementations.

1. A system for biometric identification via retina scanning, the system comprising:
a scanning laser ophthalmoscope adapted to acquire at least one retina image; and
a computer system comprising one or more processors adapted to:
analyze the image to identify retina blood vessels;
identify a plurality of branch points of the retina blood vessels;
calculate a data set that represents the identified branch points;
compare the calculated data set representing the branch points against at least one pre-stored data set representing retina branch points; and
determine whether the calculated data set corresponds to the pre-stored data set.

2. The system of claim 1, wherein:
the scanning laser ophthalmoscope is further adapted to generate a red retina image, a green retina image, and a blue retina image; and
the processor(s) are adapted to convert the three color images into a first grayscale image to analyze the image to identify the retina blood vessels.

3. The system of claim 2, wherein the processor(s) are adapted to remove foreground noise from the first grayscale image to create a second image, remove the blood vessels from the second image to create a third image, and subtract the third image from the first image to identify retina blood vessels.

4. The system of claim 1, wherein the processor(s) are adapted to thin images of the identified blood vessels to a single pixel in width to identify a plurality of branch points of the retina blood vessels.

5. The system of claim 1, wherein the processor(s) are adapted to determine a predetermined number of branch points that are the nearest neighbors to each identified branch point, determine the distances from the nearest neighbors to each branch point, and compute distance ratios between the nearest neighboring branch points for each branch point and the angles therebetween to calculate a data set that represents the identified branch points.

6. The system of claim 1, wherein the processor(s) are adapted to determine whether a predetermined number of branch points correspond between the pre-stored data set and the calculated data set to determine whether the calculated data set corresponds to the pre-stored data set.

7. The system of claim 1, wherein the processor(s) are adapted to compare the calculated data set against a plurality of data sets representing retina branch points to compare the calculated data set representing the branch points against at least one pre-stored data set representing retina branch points.

8. The system of claim 1, further comprising a security control device adapted to grant access if the calculated data set corresponds to the pre-stored data set.

9. The system of claim 1, wherein the processor(s) are adapted to determine whether blood is flowing through the retina blood vessels and deny access if there is no blood flowing through the retina blood vessels.

10. A method for biometric identification via retina scanning, the method comprising:
scanning a retina using a scanning laser ophthalmoscope to acquire at least one retina image;
analyzing the image to identify retina blood vessels;
identifying a plurality of branch points of the retina blood vessels;
calculating a data set that represents the identified branch points;
comparing the calculated data set representing the branch points against at least one pre-stored data set representing retina branch points; and
determining whether the calculated data set corresponds to the pre-stored data set.

11. The method of claim 10, wherein:
scanning a retina using a scanning laser ophthalmoscope comprises generating a red retina image, a green retina image, and a blue image retina image; and
analyzing the image to identify retina blood vessels comprises converting the three color images into a first grayscale image.

12. The method of claim 11, wherein analyzing the image to identify retina blood vessels further comprises:
removing foreground noise from the first grayscale image to create a second image;
removing the blood vessels from the second image to create a third image; and
subtracting the third image from the first image.

13. The method of claim 10, wherein identifying a plurality of branch points of the retina blood vessels comprises thinning images of the identified blood vessels to a single pixel in width.

14. The method of claim 10, wherein calculating a data set that represents the identified branch points comprises:
determining a predetermined number of branch points that are the nearest neighbors to each identified branch point;
determining the distances from the nearest neighbors to each branch point; and
computing distance ratios between the nearest neighboring branch points for each branch point and the angles therebetween.

15. The method of claim 10, wherein determining whether the calculated data set corresponds to the pre-stored data set comprises determining whether a predetermined number of branch points correspond between the pre-stored data set and the calculate data set.

16. The method of claim 10, wherein comparing the calculated data set representing the branch points against at least one pre-stored data set representing retina branch points comprises comparing the calculated data set against a plurality of data sets representing retina branch points.

17. The method of claim 10, further comprising granting access if the calculated data set corresponds to the pre-stored data set.

18. The method of claim 10, further comprising:
determining whether blood is flowing through the retina blood vessels; and
denying access if there is no blood flowing through the retina blood vessels.

19. Logic encoded on non-transitory computer-readable media, the logic adapted to, when executed by one or more processors, to cause the processor(s) to perform the following operations comprising:
analyze a retina image acquired using a scanning laser ophthalmoscope to identify retina blood vessels;
identify a plurality of branch points of the retina blood vessels;
calculating a data set that represents the identified branch points;
compare the calculated data set representing the branch points against at least one pre-stored data set representing retina branch points; and
determine whether the calculated data set corresponds to the pre-stored data set.

20. The encoded logic of claim 19, wherein the at least one retina image comprises a red retina image, a green retina image, and a blue image retina image, and analyzing the image to identify retina blood vessels comprises converting the three color images into a first grayscale image.

21. The encoded logic of claim 20, wherein analyzing the image to identify retina blood vessels further comprises:
removing foreground noise from the first grayscale image to create a second image;
removing the blood vessels from the second image to create a third image; and
subtracting the third image from the first image.

22. The encoded logic of claim 19, wherein identifying a plurality of branch points of the retina blood vessels comprises thinning images of the identified blood vessels to a single pixel in width.

23. The encoded logic of claim 19, wherein calculating a data set that represents the identified branch points comprises:
determining a predetermined number of branch points that are the nearest neighbors to each identified branch point;
determining the distances from the nearest neighbors to each branch point; and
computing distance ratios between the nearest neighboring branch points for each branch point and the angles therebetween.

24. The encoded logic of claim 19, wherein determining whether the calculated data set corresponds to the pre-stored data set comprises determining whether a predetermined number of branch points correspond between the pre-stored data set and the calculated data set.

25. The encoded logic of claim 19, wherein comparing the calculated data set representing the branch points against at least one pre-stored data set representing retina branch points comprises comparing the calculated data set against a plurality of data sets representing retina branch points.

26. The encoded logic of claim 19, further comprising granting access if the calculated data set corresponds to the pre-stored data set.

27. The encoded logic of claim 19, further comprising:
determining whether blood is flowing through the retina blood vessels; and
denying access if there is no blood flowing through the retina blood vessels.
